(19) United States
(12) Patent Application Publication
(10) Pub. No.: US 2011/0145108 A1
(43) Pub. Date: Jun. 16, 2011

(54) METHOD FOR OBTAINING INFORMATION RELATING TO A PRODUCT, ELECTRONIC DEVICE, SERVER AND SYSTEM RELATED THERETO

(76) Inventor: Magnus Birch, Svedala (SE)

(21) Appl. No.: 12/637,571

(22) Filed: Dec. 14, 2009

(51) Int. Cl. G06Q 30/00

(52) U.S. Cl. 705/27.2

(57) ABSTRACT

The present invention relates to a method, an electronic device, a server and a system to easily and quickly obtain product information of a product selected by a user from a picture or movie. The method for obtaining information comprises the steps displaying at least one image to a user by a display section of said electronic device; selecting a product by registering a position on said display section associated with said product; and retrieving product information from a storage section using said registered position.

### FIELD OF THE INVENTION

The present invention relates to a method for obtaining information relating to a product, an electronic device, a server and a system related thereto, and in particular to obtaining product information of a product selected by a user from a picture or movie.

### BACKGROUND

In new media, such as the internet, advertising plays a major role, since users are often not willing to pay for content. Although it is very easy to obtain information in today's information society, a lot of it is actually not desired by a user, such as the user of the internet. Advertising banners and pop-ups are a common form of advertisement but also often annoying to the user so that several browsers are available that enable the blocking of pop-ups or banners.

On the other hand, a more interesting and subtle form of advertising, so-called product placement, was introduced, in which a product and its characteristics are highlighted in an environment which is not expected to be related to an advertisement. For example, the super hero in a movie drives a specific car or uses a specific electronic gadget to save the world. However, since this type of advertisement is not very pushy, the user's attention to that product will not last much longer than to the end of the movie. Therefore, to achieve an advertisement effect at all, the brand has to be shown clearly, which is again pushy. Further, it is difficult for the user to obtain more information about the product when watching or listening to a movie, pictures or songs.

This is usually done at the end of the movie and at that time the user may have forgotten already that she/he was interested in the product.

Therefore, it is desirable to provide a method, electronic device, server and system that support a user in obtaining product information easily and quickly.

### DISCLOSURE OF THE INVENTION

A method and electronic device for obtaining information relating to a product, as well as a server for providing product information and a system for obtaining product information are presented and defined in the independent claims. Advantageous embodiments are defined in the dependent claims.

An embodiment of the invention provides a method for obtaining information relating to a product to be reproduced by an electronic device. The method comprises the steps of displaying at least one image to a user by a display section of the electronic device, selecting a product by registering a position on the display section associated with a product, and retrieving product information from a storage section using the registered position. Accordingly, product information may be associated with a position on the display section so that a user may easily obtain product information by simply selecting a product based on its position on the display section. Therefore, product information can be obtained when watching or listening to a movie, pictures or songs, respectively.

In one embodiment, the retrieving step of the method comprises comparing the registered position with a previously stored position associated with product information and providing the product information to the user, if the comparing step determines that the registered position matches with the stored position. Accordingly, product information and a corresponding position of the product in the picture or movie may be prestored in a table of a database, for example, so as to enable a simple position comparison to provide desired product information.

In one embodiment, the selecting step of the method comprises registering the time of selection and the position on the display section associated with the product. Further, the retrieving step of the method may comprise comparing the registered position and time with a previously stored position and time associated with product information and providing the product information to the user, if the comparing step determines that the registered position and time match with the stored position and time. Accordingly, a registered position and time are compared to a stored position and time associated with product information so as to provide a simple mechanism to retrieve desired product information that may be provided to a user if a match in position and time is determined.

In one embodiment, the displaying step of the method comprises sequentially displaying a plurality of images to the user. Accordingly, depending on the speed of subsequent images, a slideshow or movie may be presented to the user and product information may be extracted although a large number of images and thus visual information exists.

In one embodiment, the method further comprises the step of transmitting from the electronic device the registered position or the registered position and time to a server including the storage section. Accordingly, the method can be performed in a distributed environment, in which position and/or time is registered at the electronic device and transmitted to a server having a storage section, such as a database in a database unit, in which product information can be looked up. Therefore, a large amount of product information that depends on a position, time and possibly on the movie, picture or song, may be outsourced to a server connected via a fixed line or a wireless network.

In one embodiment, the method comprises the step of receiving at the electronic device the product information from a server including the storage section. Accordingly, the electronic device can be adapted to provide the user with product information without having to store the product information in its storage so that a large amount of product information can be outsourced to a server being connected to the electronic device via a fixed line or wireless network. Therefore, similar to the transmitting step discussed above, also the receiving step may be performed via wireless communication.

In one embodiment, the retrieved product information comprises an internet address of a website featuring the product. For example, the product may be ordered via the website. Accordingly, product placement is efficiently connected with product information and product ordering.

Another embodiment of the invention provides an electronic device for obtaining information relating to a product. The electronic device comprises a display section operable to display images to a user of the electronic device, an input interface operable to register a position on the display section associated with the product selected by the user, and a communication section adapted to transmit the registered position to a server comprising a storage section storing product information and to receive product information from the server using the registered position. Accordingly, product information may be obtained by the user directly with only one click or touch, for example, without having to remember the product name.

Another embodiment of the invention provides a server for providing information relating to a product. The server comprises a receiving unit operable to receive a registered position from an electronic device; a storage section operable to store product information associated with a previously stored position; a comparing unit operable to compare the received registered position with the stored position associated with product information; and a providing unit operable to provide product information from the storage section if the comparing unit determines that the received registered position matches with the stored position. Accordingly, an information providing server may be used to outsource product information that is demanded by a user of an electronic device, wherein the desired product information is obtained by using a registered position of a selected product.

Another embodiment of the invention provides a system for obtaining information relating to a product to be reproduced by an electronic device. The system comprises a display section operable to display images to a user; an input interface operable to register a position on the display section associated with a product selected by the user; and a retrieving section operable to retrieve product information from a storage section using the registered position. Accordingly, a system is established to provide a user with product information of a product shown in an image or images, such as pictures or a movie, or heard in a movie.

In one embodiment, the retrieving section of the system comprises a comparing unit operable to compare the registered position with a stored position associated with product information; and a providing unit operable to provide product information if the comparing unit determines that the registered position matches with the stored position.

Another embodiment of the invention provides a system for obtaining information relating to a product to be reproduced by an electronic device, wherein the system comprises means for displaying at least one image to a user by a display section of the electronic device; means for selecting a product by registering a position on the display section associated with a product; and means for retrieving product information from a storage section using the registered position.

In one embodiment the system comprises the above-described electronic device and the above-described server.

### BRIEF DESCRIPTION OF THE DRAWINGS

Embodiments of the invention will be described with respect to the following appended figures.

FIGS. 1A, 1B and 1C illustrate electronic devices and elements thereof, wherein in FIG. 1A an electronic device in general according to an embodiment of the invention is shown, in FIG. 1B a specific example of an electronic device, namely a mobile phone, according to a specific embodiment of the invention is shown and in FIG. 1C a block diagram of the mobile phone is shown.

FIG. 2 illustrates a flow diagram of a method for obtaining information relating to a product according to an embodiment of the invention.

FIGS. 3A and 3B illustrate modifications of the flow diagram of the method shown in FIG. 2 according to specific embodiments of the invention.

FIG. 4 illustrates a server and elements thereof including a storage section according to an embodiment of the invention.

FIG. 5 illustrates a system and elements thereof according to an embodiment of the invention.

FIG. 6 illustrates a process of how the concept of the invention may be applied.

### DESCRIPTION OF THE EMBODIMENTS

Embodiments of the invention are described with reference to the figures. It is noted that the following description contains examples only and should not be construed as limiting the invention.

In the following, similar or same reference signs indicate similar or same elements.

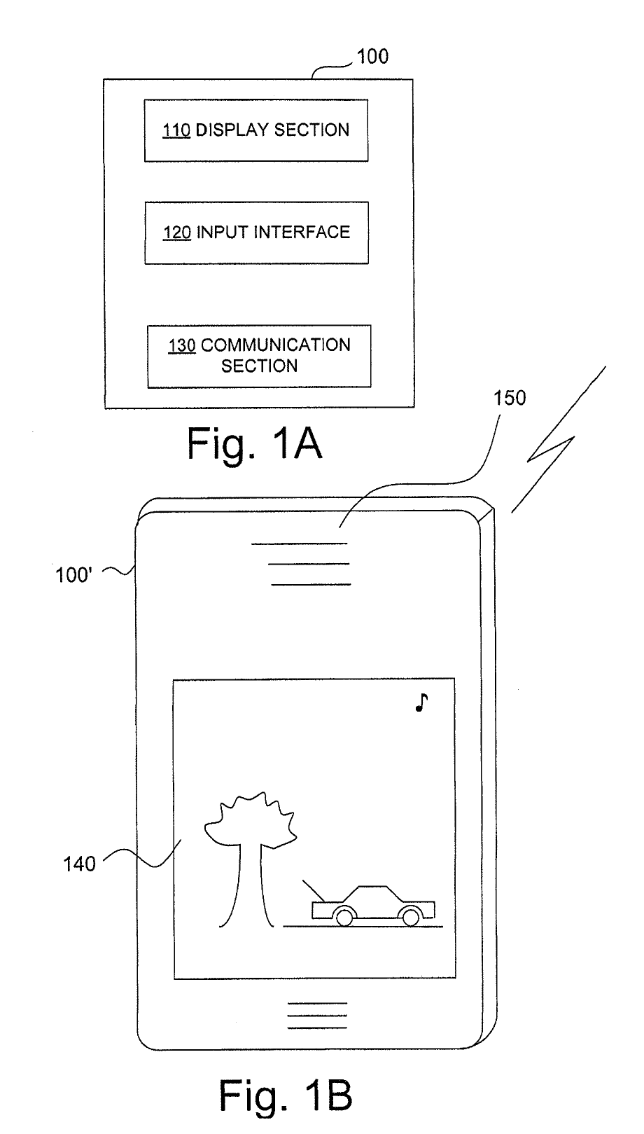

FIG. 1A illustrates elements of an electronic device according to an embodiment of the invention. FIG. 1A illustrates particularly the electronic device 100 comprising a display section 110, an input interface 120 and a communication section 130.

The electronic device 100 may be a hand-held mobile device, such as a mobile phone or a personal digital assistant (PDA) or portable media player for watching movies, etc., but is not necessarily limited to a mobile device so that the electronic device may also constitute a desktop computer.

The display section 110 of the electronic device 100 displays images to a user of the electronic device 100. Preferably, the display section is a liquid crystal display (LCD) or an organic light emitting diode (OLED) display to display a picture showing a product or to display multiple images in sequence, i.e. a movie. In addition to the video capability of the display section 110, the electronic device may also comprise audio capabilities, such as a loudspeaker or a headphone connector to connect headphones to listen to music or a sound of a movie.

The input interface 120 registers a position on the display section 110 associated with a product selected by the user. As described above, an image or multiple images on the display section may comprise a representation of a product, i.e. an image of a product, in which the user might be interested. The user may then indicate her/his interest in the product by selecting the product on the display section, for example by using a pointing device, such as a mouse, a track ball or joystick or touch capabilities to indicate the position of the product of interest on the display section 110. For example, the display section 110 and the input interface 120 may be realized by a touch screen device combining both functions, namely displaying an image and allowing an input operation on top of the image so that a specific part of the image, e.g. showing a product, may be selected.

When the product is selected by the user, the position of the product and indicated by the user is registered by the input interface 120. For example, the x,y-coordinates of the position on the display are registered.

The communication section 130 transmits the registered position to a database unit, such as a server comprising a storage section for storing product information, and receives product information from the database unit using the registered position. For example, which will be described in more detail below, the storage section may include a table in which product information and corresponding position information is stored and if a registered position is received, the registered position, such as its x,y-coordinates, is compared to the stored positions, such as their x,y-coordinates, and if there is a match between the positions, namely a stored position and the registered position, the product information corresponding to said stored position is retrieved.

It is understood that the communication section may also be represented by a combination of a receiving section and a transmitting section to fulfil the functions described with respect to FIG. 1A.

In FIG. 1B, an example of an electronic device is presented. In this example, the electronic device is a mobile phone 100′ with a touch screen device 140 and a loudspeaker 150. A block diagram of the mobile phone is presented in FIG. 1C in which a controller of the mobile phone is connected to a touch screen and a RAM and a baseband chip (BB-chip) that is in turn connected to a radio frequency chip (RF-chip) so that the controller controls the functions of the mobile phone.

In the example of FIG. 1B, a car, a tree and a note are displayed on the touch screen device 140 which constitutes a combination of a display section and an input interface. If the user is interested in more information on the car, the user may then select the car by touching it with a finger or a stylus and the touch screen device 140 registers the position on the display of the touch screen device associated with the product.

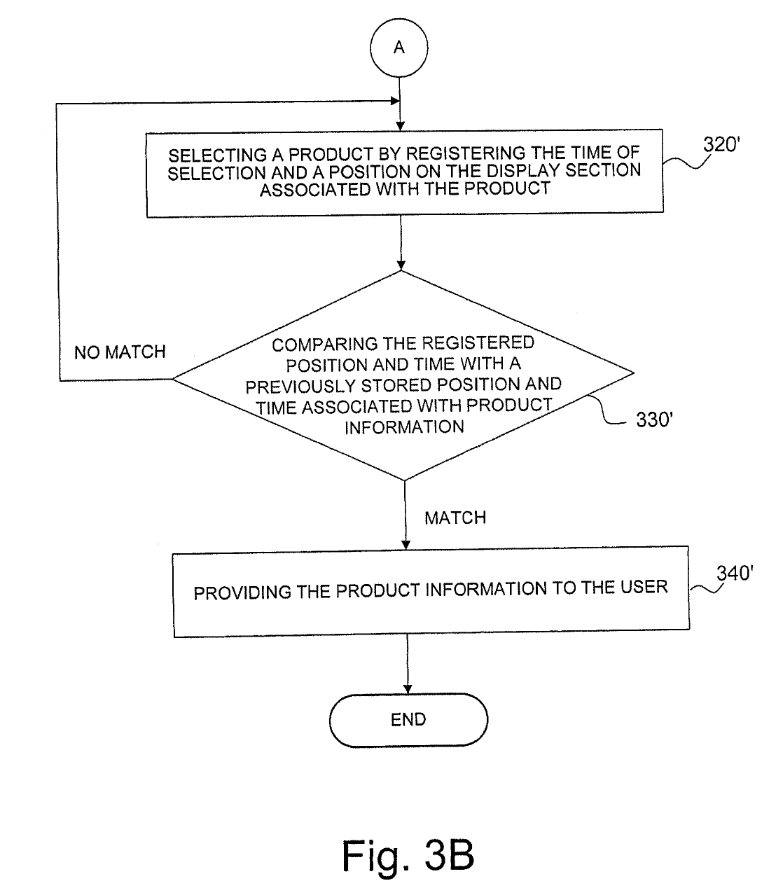

The controller of the mobile phone forwards the data of the registered position to the baseband chip and the baseband data is then modulated on a carrier wave in order to be transmitted via radio by the radio frequency-chip. This radio transmission may then be received by a database unit, such as the server 400 of FIG. 4 that comprises a storage section from which product information may be retrieved using the data of the registered position. The corresponding product information may then be sent back to the mobile phone, received via the RF-chip and BB-chip and then stored in the RAM or displayed on the touch screen device.

When a picture or movie is shown on the touch screen device 140, there may be also sound, such as music, playing which can be heard through the loudspeaker 150, for example. If the user is interested in more information on the music or in buying the piece of music, the user may simply click or touch on the note in the upper right corner and the mobile phone connects to the server and the information on the piece of music is retrieved from the storage section in the server and/or the piece of music is downloaded and stored in the RAM or other memory of the mobile phone, for example, in a folder with the same name as the movie.

Instead of displaying a note somewhere on the display, it is also feasible to define a certain position as the position corresponding to information on music playing. Therefore, for example, the lower left corner may be predefined as the position, and when pressed the music which is playing is retrieved.

It is understood that in the above example network traffic is generated between the mobile phone and the server when information about the product or the product itself, in the case of music, is downloaded, thereby creating a new form of advertising and sales channel.

Before describing the server 400 of FIG. 4 in more detail, operations performed in the electronic device and in conjunction with the server are presented.

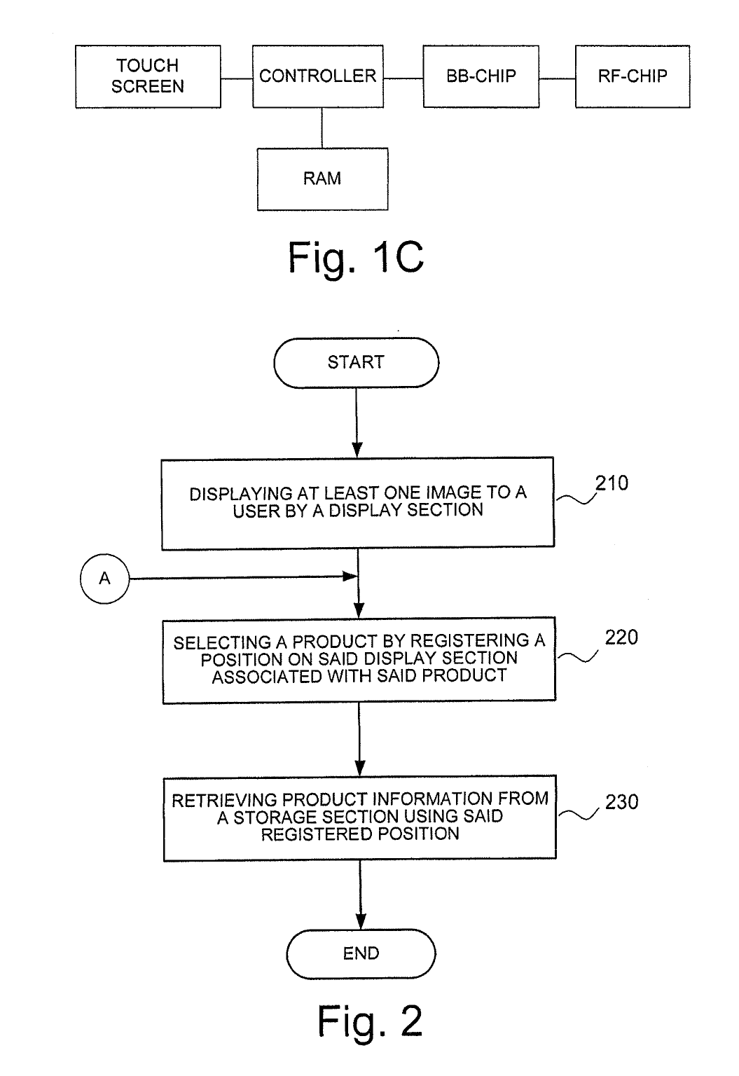

FIG. 2 illustrates operations of a method for obtaining information relating to a product to be reproduced by an electronic device, such as the electronic device which is described with respect to FIGS. 1A and 1B. To be more specific, the reproduced product may actually be a representation of a product, wherein the product may be a tangible or intangible product, such as a car or music.

In a first step 210, at least one image is displayed to a user. Displaying can be performed by a display section of the electronic device shown in FIG. 1A, which comprises a display section 110, an input interface 120 and a communication section 130.

Subsequently in step 220, as shown in FIG. 2, a product is selected by registering a position on the display section associated with a product. For example, the product, i.e. an image or representation of the product, is shown in an image displayed by the display section and the user uses a mouse, a track ball or other pointing device to indicate the position on the display section corresponding to the shown product. For example, the display section may be configured to allow for operation as input interface, such as a touch screen device which is described in more detail above.

In step 230 product information, such as the name of the displayed picture, movie or piece of music, etc., is retrieved from a storage section using the previously registered position. Therefore, product information can be obtained and provided to the user using the registered position.

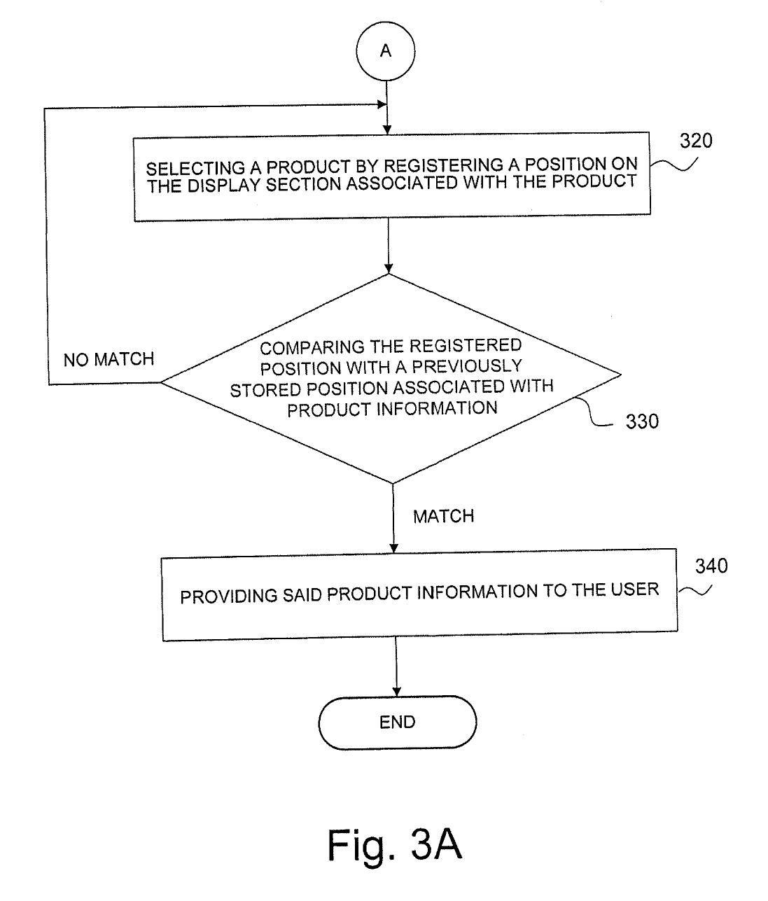

For example, as shown in FIG. 3A, the retrieving step of FIG. 2 comprises or may be replaced by comparing the registered position with previously stored position associated with product information, as shown in FIG. 3A, step 330, and by providing the product information to the user, if the comparing step 330 determines that the registered position matches with the stored position, as shown in step 340.

As shown in FIG. 3A, the process flow goes from step 330 to step 340 if there is a match between the positions and returns to step 320, which is the step for selecting a product by registering a position, if there is no match. In one example, instead of returning to step 320, it is also possible that if there is no match, the process returns to the displaying step 210 described in FIG. 2 so that a new image may be displayed, as for example done in a movie.

In another example described with respect to FIG. 3B, the retrieving step 230 may comprise or be replaced by steps 330′ and 340′ of FIG. 3B and the selecting step 220 may be replaced by the selecting step 320′.

In detail, as described in FIG. 2, one or more images are displayed to a user in a first step, and the user selects a product. As indicated in step 320′, the product in FIG. 3B is selected by registering the time of selection and the position on the display section associated with a product. For registering the time of selection, a time stamp with the current time may be used, which is in particular appropriate for movies, since the position of the product will change in time. In movies, the time stamp may indicate the point in time calculated from the start of the movie. This time is usually readily available in movie files in the MPEG-format.

In step 330′, following step 320′ the registered position and time is compared with a previously stored position and time associated with product information. Similar to FIG. 3A, the process flow advances to step 340′, if a match is determined and product information is provided to the user. In other words, product information is provided to the user, if the comparing step 330′ determines that the registered position and time match with the stored position and time.

As shown in FIG. 3B, if there is no match, the process flow returns to step 320′ and another position at a different point in time can be selected. If a plurality of images is sequentially displayed, at different points in time, a different product may be at the same position so that the user may select a different product by registering the same or different position at a later time.

As described above, the selection of a product may be performed by either a pointing device, such as a mouse, a track ball, etc., such as commonly known from a desktop computer, or may be selected by touching a certain position of a touch screen device. In both cases, the registered position may include x,y-coordinates corresponding to the pressed or clicked location, optionally also polar coordinates may be used.

The x,y-coordinates may then be compared to previously stored positions, i.e. previously stored x,y-coordinates which are associated with product information.

For example, if a specific car is presented in a movie, the coordinates or range of coordinates (since the car is usually presented with a specific size on the display device) are stored together with the time at which the car is at the stored coordinates in a database. Then, when a product is selected and a position and a specific time of selection are registered, the registered position and time are compared to the stored positions and times and it is determined whether a match exists.

In this context, it should be noted that there are different ways of matching and matching does not have to necessarily be understood as a one-to-one correspondence between registered position and time and stored position and time, since also small deviations in the position should be allowed due to the accuracy of the registered data and the stored data. Therefore, a match may also be determined when the registered and stored position are slightly different, e.g. by 10%.

Since the position of a product on the display section may be dependent on the kind of display section having different resolutions, registering the model of the electronic device, which specifies also the display section, may be advantageous so that this criterion could also be used together with the position and time to retrieve desired product information accurately. Similarly, the name of the picture or movie which is shown on the electronic device should be registered and also used for retrieving product information.

Furthermore, several electronic devices, in particular portable electronic devices, such as smart phones, allow to view pictures or movies either in the landscape format or when tilted in a portrait format so that also the format change may introduce a size change thus changing the position of the product on the display section so that it may be desirable to register this information and provide this information to retrieve product information which will be described in the following in more detail.

In the following, a server for providing information relating to a product is described with respect to FIG. 4. The server 400 of FIG. 4 comprises a receiving unit 410, a storage section 420, a comparing unit 430, and a providing unit 440. In brief, the server basically functions as a database unit storing product information and associated positions and compares received registered positions with stored positions to provide desired product information.

In detail, the receiving unit 410 receives a registered position from an electronic device, such as electronic device 100 or 100′. More specifically, the received registered position may be received in form of position data or position information indicating x,y-coordinates of a display section on which a picture or movie is shown.

The storage section 420 stores product information associated with a previously stored position. In the example of FIG. 1B product information may include characteristics of the car shown in FIG. 1B, such as horse power, cylinders, top speed and price, wherein this product information is associated with the position of the car in the image. To be more specific, before displaying the picture with the car and the tree to a user on a mobile device, the position of the car is stored together with product information in the storage section. Since the car in the picture has a certain extent, the stored position may be a position range, i.e. a plurality of positions, such as x, y-coordinates, covered by the car.

The comparing unit 430 compares the received registered position with the stored position or stored positions associated with the product information.

If the comparing unit 430 determines that the received registered position matches with a stored position, the providing unit 440 provides the corresponding product information from the storage section 420 to the electronic device, e.g. electronic device 100.

Similar to the discussion with respect to FIG. 1B, the product information may be transmitted via wireless communication from the server and be received by the electronic device.

As discussed above, the electronic device transmits the registered position or the registered position and time, for example in the case of a movie, to the server. These transmissions of the electronic device and the server may be performed via wireless communication, such as the UMTS, GPRS, GSM, WLAN, Bluetooth, etc.

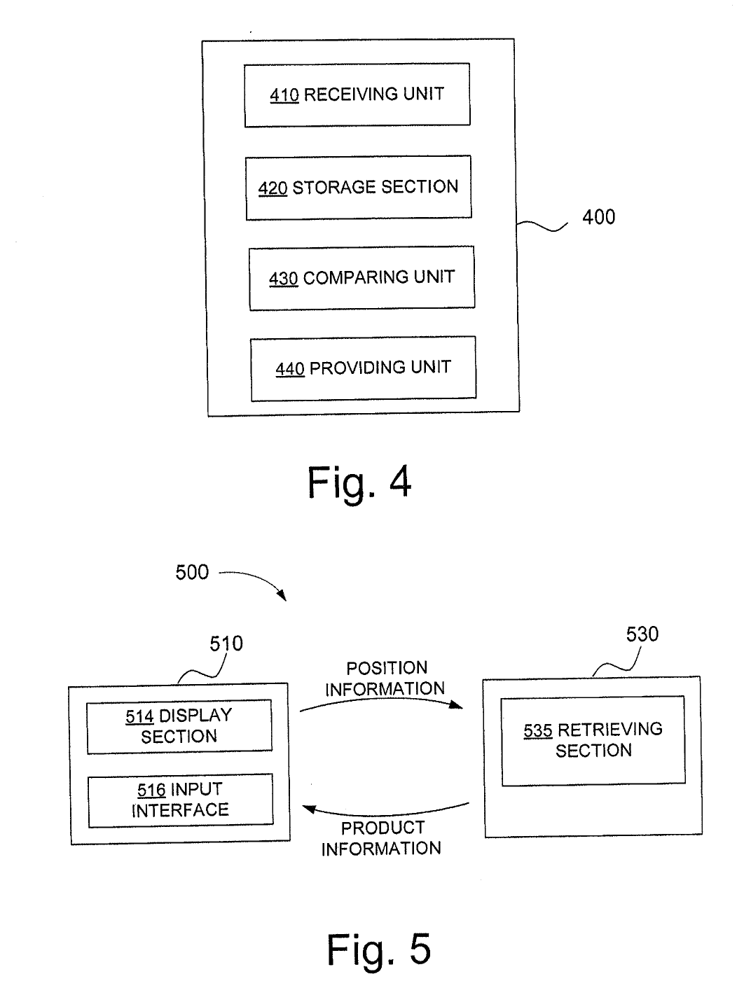

In the following, a system for obtaining information relating to a product is described with respect to FIG. 5. The system 500 shown in FIG. 5 comprises a display section 514, an input interface 516 and a retrieving section 535.

The display section 514 and input interface 516 are adapted to display images to a user and register a position on the display section associated with a product selected by the user, respectively, and thus their functions are the similar to the functions of the display section 110 and the input interface 120 or the touch screen device 140 described in FIGS. 1A and 1B and a more detailed explanation is omitted to avoid unnecessary repetition. The display section 514 and the interface 516 may be placed in an electronic device 510, such as a mobile phone, or one of the above-described electronic devices.

The retrieving section 535 retrieves product information from a storage section using the registered position. The retrieving section 535 may also be placed in the electronic device 510, however, the retrieving section is preferably placed in a server comprising the storage section and since the storage section may comprise vast amounts of data relating to several pictures and movies and product information of products shown in the pictures and movies as well as associated positions of the products in the movies, the amount of data is large and it is desirable that the retrieving section 535 and the storage section are placed in a remote server 530 that may communicate with the electronic device 510. Accordingly, it is not necessary to keep all information of the database on the electronic device 510 and the electronic device 510 only needs to provide the server 530 with the position information and if necessary, such as in a movie, time information and receives in turn product information as indicated in FIG. 5.

The retrieving section 535 may be realized by a comparing unit and a providing unit, wherein the comparing unit compares the registered position with a stored position associated with product information and the providing unit provides product information if the comparing unit determines that the registered position matches with the stored position. Therefore, the comparing unit and the providing unit are basically the same as the comparing unit 430 and the providing unit 440 described with respect to FIG. 4.

The display section 514 may basically serve as means for displaying at least one image to a user and the input interface may serve as means for selecting a product by registering a position on the display section associated with a product. Further, the retrieving section 535 may serve as means for retrieving product information from the storage section using the registered position.

As became clear from the above, the storage section 420 of the server 400 should be able to store a large amount of data relating to a plurality of movies and/or pictures, wherein products featured in the movies or pictures are associated with position information, such as x, y-coordinates and time stamps. Furthermore, since different displays can be used in electronic devices and pictures or movies may be viewed in either landscape or portrait format by tilting the electronic device by ninety degrees, the registered position may be dependent on the display and format used so that in addition to the registered position and the time stamp, if applicable, also the model of the electronic device or the display and format used as well as the name of the movie or picture should be transmitted to the server 400. In the server, a controller may be provided to calculate from the registered position depending on the model and format a global registered position independent on the model and the format which is then compared to stored positions for the individual picture or movie viewed.

Therefore, maintaining and managing the server, and in particular the storage section 420 is a complicated task that may be distributed to different entities. For example, a tool may be provided to manufacturers of the products shown in a movie to let them store product information of their product and positions and time stamps of their product in a predefined way. This information may then be transferred to the storage section. In this way, the manufacturers may acquire storage space in the storage section 420 so that the product information can get to the user.

Alternatively, also the network operator or any other entity, such as a film distributor, may control, manage and update the storage section 420.

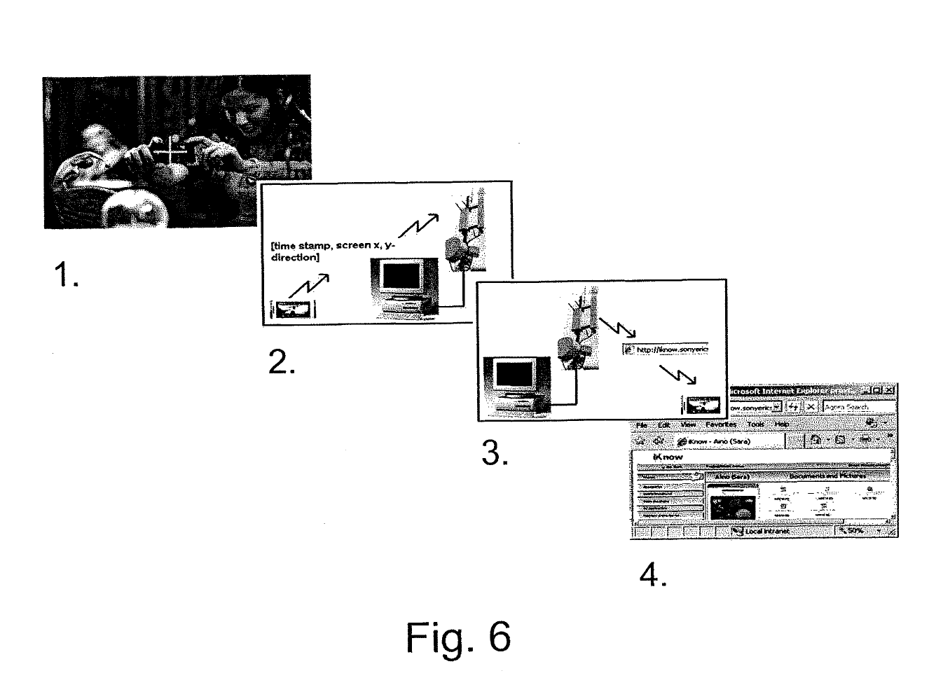

The following example summarizes the above-described operations which are explained with respect to FIG. 6.

In slide 1 an image is shown on a touch screen device of a mobile phone and a user touches with a finger on the touch display, which is indicated by the white cross. Thereby, the user indicates her/his interest in the camera held by the person in the image. The position of the white cross is registered and also, if applicable, the time at which the touch display was touched, and a time stamp and the position of the white cross in the x, y-direction (polar coordinates are also possible) are sent to a database unit, such as the server described with respect to FIG. 4.

Alternatively, the position and time stamp may also be stored in a favourite list from which product information can be obtained at a later stage.

The computer shown in slide 2 represents a database server which is connected to a base station acquiring position and time information wirelessly from the mobile device.

As shown in slide 3 the database server sends product information wirelessly from the database unit back to the mobile phone together with an internet address. The internet address is an internet address of a website featuring the product, and once this internet address is obtained at the electronic device, as shown in slide 4, the touch display of the electronic device loads the corresponding website featuring the product previously touched. In a subsequent step, the same product may be ordered via the website.

The above description has mentioned several individual elements, such as the display section, input interface, communication section, controllers, receiving unit, storage section, comparing unit, providing unit and retrieving section, and it should be understood that the invention is not limited to these elements being independent structural units but these elements should be understood as elements comprising different functions.

In other words, it is understood by the skilled person that an element in the above-described embodiments is not construed as being limited to a separate tangible part but it is understood as a kind of functional entity so that several functions may also be provided in one tangible part or even where an element, such as the controller of the electronic device or the controller of the server or the communication section, performs several functions, these functions may be distributed to different parts. In particular, the display section and input interface may be realized by one element, namely by a touch screen device and the communication section may be realized by two elements, namely a baseband chip and a radio-frequency chip.

Moreover, physical entities according to the invention and/or its embodiments and examples may comprise or store computer programs including instructions such that, when the computer programs are executed on the physical entities, such as the controller of the electronic device including a processor, CPU or similar, steps, procedures and functions of these elements are carried out according to embodiments of the invention. For example, the controller controls the display section 110 to display a picture and forwards a registered position to the communication section and controls the communication section 130 to transmit the registered position.

Accordingly, specially programmed software can be used to be run on a processor, e.g. contained in the controller, to control the above-described functions, wherein the software may be stored in the RAM in the case of the electronic device of FIGS. 1A to 1C. Similarly, the controller of the server 400 may also contain a processor on which software is run to carry out functions of the elements of the server, such as the functions of the comparing unit 430.

The invention also relates to computer programs for carrying out functions of the elements, such as the method steps described with respect to FIGS. 2 and 3.

The above-described elements of the electronic devices 100, 100′, 510 and servers 400 and 530 may be implemented in hardware, software, field-programmable gate arrays (FPGAs), application-specific integrated circuits (ASICs), firmware or the combinations thereof.

It will be appreciated that various modifications and variations can be made in the described elements, electronic devices, servers, systems and methods as well as in the construction of this invention without departing from the scope or spirit of the invention. The invention has been described in relation to particular embodiments which are intended in all aspects to be illustrative rather than restrictive. Those skilled in the art will appreciate that many different combinations of hardware, software and firmware are suitable for practising the invention.

Moreover, other implementations of the invention will be apparent to the skilled person from consideration of the specification and practice of the invention disclosed herein. It is intended that the specification and the examples are considered as exemplary only. To this end, it is to be understood that inventive aspects may lie in less than all features of the single foregoing disclosed implementation or configuration. Thus, the true scope and spirit of the invention is indicated by the following claims.

1. Method for obtaining information relating to a product to be reproduced by an electronic device, comprising the steps
displaying at least one image to a user by a display section of said electronic device;
selecting a product by registering a position on said display section associated with said product; and
retrieving product information from a storage section using said registered position.

2. Method of claim 1, wherein said retrieving step comprises the steps
comparing said registered position with a previously stored position associated with product information; and
providing said product information to said user, if said comparing step determines that said registered position matches with said stored position.

3. Method of claim 1, wherein said selecting step comprises the step
registering the time of selection and said position on said display section associated with said product; and
wherein said retrieving step comprises the steps
comparing said registered position and time with a previously stored position and time associated with product information; and
providing said product information to said user, if said comparing step determines that said registered position and time match with said stored position and time.

4. Method of claim 1, wherein said displaying step comprises
sequentially displaying a plurality of images to said user.

5. Method of claim 1, further comprising the step
transmitting from said electronic device said registered position or said registered position and time to a server comprising said storage section.

6. Method of claim 1, further comprising the step
receiving at said electronic device said product information from a server comprising said storage section.

7. Method of claim 5, wherein at least one of said transmitting step and receiving step is performed via wireless communication.

8. Method of claim 1, wherein said retrieved product information comprises an internet address of a web site featuring said product.

9. Method of claim 8, further comprising the step
ordering said product via said web site.

10. Electronic device for obtaining information relating to a product, comprising
a display section operable to display images to a user of said electronic device;
an input interface operable to register a position on said display section associated with said product selected by said user; and
a communication section adapted to transmit said registered position to a server comprising a storage section storing product information and to receive product information from said server using said registered position.

11. Server for providing information relating to a product, comprising
a receiving unit operable to receive a registered position from an electronic device;
a storage section operable to store product information associated with a previously stored position;
a comparing unit operable to compare said received registered position with said stored position associated with product information; and
a providing unit operable to provide product information from said storage section if said comparing unit determines that said received registered position matches with said stored position.

12. System for obtaining information relating to a product to be reproduced by an electronic device, comprising
a display section operable to display images to a user;
an input interface operable to register a position on said display section associated with said product selected by said user; and
a retrieving section operable to retrieve product information from a storage section using said registered position.

13. System of claim 12, wherein said retrieving section comprises
a comparing unit operable to compare said registered position with a stored position associated with product information; and
a providing unit operable to provide product information if said comparing unit determines that said registered position matches with said stored position.

14. System for obtaining information relating to a product to be reproduced by an electronic device, comprising
means for displaying at least one image to a user by a display section of said electronic device;
means for selecting a product by registering a position on said display section associated with said product; and
means for retrieving product information from a storage section using said registered position.

15. System for obtaining information relating to a product, comprising an electronic device for obtaining information relating to a product, comprising
a display section operable to display images to a user of said electronic device;
an input interface operable to register a position on said display section associated with said product selected by said user; and
a communication section adapted to transmit said registered position to a server comprising a storage section storing product information and to receive product information from said server using said registered position, and
the server of claim 11.
